(19) United States
(12) Patent Application Publication
(10) Pub. No.: US 2010/0164812 A1
(43) Pub. Date: Jul. 1, 2010

(54) SWITCHED NON-RESONANT ANTENNA LOAD

(75) Inventors: PREM K. GANESHAN, ARLINGTON HEIGHTS, IL (US); VIJAY L. ASRANI, ROUND LAKE, IL (US); MICHAEL K. SIMCOE, TEMPE, AZ (US)

Correspondence Address: PATENTS ON DEMAND, P.A.-Motorola, 4581 WESTON ROAD, SUITE 345, WESTON, FL, 33331, US

(73) Assignee: MOTOROLA, INC., SCHAUMBURG, IL (US)

(21) Appl. No.: 12/347,238

(22) Filed: Dec. 31, 2008

(51) Int. Cl. H01Q 9/00; H01Q 1/24

(52) U.S. Cl. 343/702; 343/749

(57) ABSTRACT

A mobile communication device (100) is operable in several physical configurations (202, 204, 302, 304) and has a main antenna (108). A non-resonant load (124) is selectively coupled to the main antenna during transmit time slots (808) to change the operating resonance of the antenna and reduce the field strength produced by the antenna at one or more select locations of the mobile communication device.

### FIELD OF THE INVENTION

The invention relates generally to antennas for mobile communication devices, and more particularly to antenna design for hearing aid compatibility in mobile communication devices.

### BACKGROUND OF THE INVENTION

The Federal Communications Commission has mandated that manufacturers of mobile communication devices must offer a certain number of mobile communication device designs which are hearing aid compatible. Hearing aids use one of two modalities when used with a mobile communication device; either the microphone of the hearing aid is used to acquire the acoustic signal produced by the earpiece speaker of the mobile communication device, or the hearing aid uses a telecoil to pick up the magnetic field signal produced by the earpiece speaker or a corresponding telecoil of the mobile communication device. A primary concern for hearing aid compatibility is to ensure of the hearing aid in the presence of the field around the mobile communication device when the mobile communication device is transmitting. Radio frequency signals can couple into the hearing aid circuitry and affect operation of the hearing aid. The potential for such interference is increased in mobile communication devices using a time division multiple access communication protocol, such as that mandated by the well-deployed Global System for Mobile communication (GSM) specification. Furthermore, it has been found that mobile communication devices which are physically reconfigurable, such as those having folding or sliding body members, present particular challenges for hearing aid compatibility due to the changes in radiation characteristics when the device's physical configuration is changed from one configuration to another. Market pressures have tended to force designers to adopt small, internal antenna structures in new designs, limiting the space available for antennas, and given that mobile communication devices typically operate in multiple frequency bands, there is a need for a means by which mobile communication devices can achieve the required hearing aid compatibility performance.

### SUMMARY OF THE INVENTION

The invention provides in one embodiment a method of controlling operation of a switched non-resonant antenna element in a mobile communication device. The switched non-resonant antenna element is disposed in proximity, meaning electrical proximity, to a main antenna and is switchably coupled to an electrical reference. The method commences by determining a configuration of the mobile communication device. The mobile communication device is configurable in at least a first and a second physical configuration. When the mobile communication device is configured in the first physical configuration, the method commences by leaving the non-resonant antenna element in a decoupled state from the electrical reference. When the mobile communication device is configured in the second physical configuration, the method commences by selectively coupling the non-resonant antenna element to the electrical reference through an impedance during a transmit slot time, and decoupling the non-resonant antenna element from the electrical reference during a receive time slot.

The invention further provides, in another embodiment, a method of configuring an antenna structure of a mobile communication device, commenced by determining a configuration of the mobile communication device, wherein the mobile communication device is configurable in at least a first and a second physical configuration. When the mobile communication device is configured in the first physical configuration, the method commences by selecting a first non-resonant antenna element impedance configuration wherein a first non-resonant load is coupled between an electrical reference and a main antenna during a transmit slot time, and decoupled from the electrical reference during a receive time slot. When the mobile communication device is configured in the second physical configuration, the method commences by selecting a second non-resonant antenna element impedance configuration wherein a second non resonant load is coupled between an electrical reference and the main antenna during a transmit slot time, and decoupled from the electrical reference during a receive time slot.

In a further embodiment of the invention, a mobile communication device comprises a first body portion and a second body portion, wherein the first and second body portions are moveable with respect to each such that the mobile communication device is operable in at least a first physical configuration and a second physical configuration. The mobile communication device further comprises a main antenna, and at least one non-resonant impedance load which is switchably coupled between the main antenna and an electrical reference during a transmit slot time, and decoupled from the electrical reference during a receive time slot when the mobile communication device is configured in the first physical configuration.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 shows a schematic diagram of a mobile communication device, in accordance with an embodiment of the invention;

FIG. 2 shows a mobile communication device in a clamshell design, in accordance with an embodiment of the invention;

FIG. 3 show a mobile communication device in a slider design, in accordance with an embodiment of the invention;

FIG. 4 shows an antenna structure including a non-resonant load which may be switchably coupled to a main antenna, in accordance with an embodiment of the invention;

FIG. 5 shows an antenna structure including a plurality of non-resonant loads which may be switchably coupled to a main antenna, in accordance with an embodiment of the invention;

FIG. 6 shows a multi-resonant antenna structure including non-resonant impedance loads, in accordance with an embodiment of the invention;

FIG. 7 shows a lookup table for use in selecting an impedance configuration, in accordance with an embodiment of the invention;

FIG. 8 shows a switch timing diagram for operating switched non-resonant impedance loads, in accordance with an embodiment of the invention;

FIG. 9 shows a graph of return loss verses frequency for a switched and un-switched state of an impedance load, in accordance with an embodiment of the invention; and

FIG. 10 shows a flow chart diagram of a method of controlling operation of a switched non-resonant impedance load, in accordance with an embodiment of the invention.

### DETAILED DESCRIPTION OF THE INVENTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

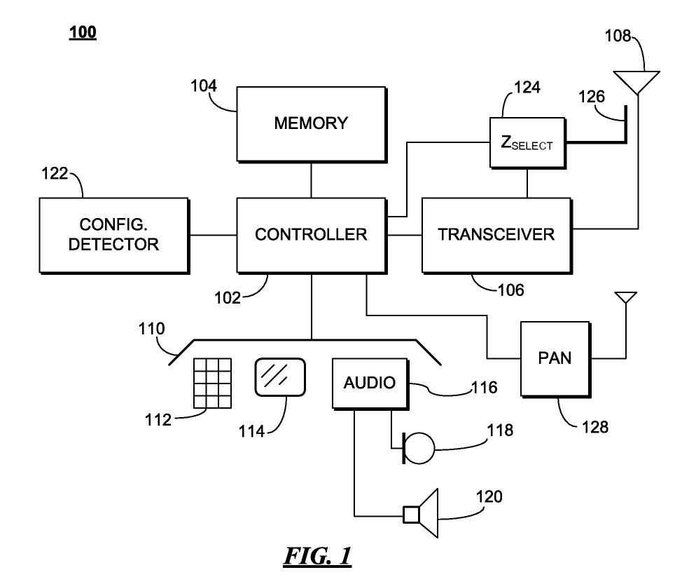

The invention solves of the problems related to small internal antennas and hearing aid compatibility by use of a switched non-resonant impedance load which is switched on during transmit time slots, thereby shifting the frequency response of the antenna and the field shape produced by the antenna such that the field strength at the earpiece of the mobile communication device is sufficiently reduced for hearing aid compatibility. Referring to FIG. 1, there is shown a schematic diagram of a mobile communication device 100 designed in accordance with an embodiment of the invention. The mobile communication device comprises a controller 102 which operates in accordance with instruction code stored in a memory 104. The controller has input and output capability, as well as processing and instruction execution capability, as is well practiced in the art. The controller 102 operates with a transceiver 106, which performs radio frequency operations for transmitting and receiving signals over an antenna 108. The transceiver comprises frequency generation, modulation, mixing, filtering, and amplification components, as is conventional. The antenna may be an internal antenna, disposed within a housing of the device 100. The device may be operable by use of a user interface 110, which may include user interface elements such as a keypad 112 and other button or tactile input means, a graphic display 114 for displaying information to a user, and an audio processor 116 which converts electrical audio signals into acoustic signals through a speaker 120 such as an earpiece or loudspeaker, and converts acoustic signals into electrical signals received via a microphone 118. The mobile communication device is a multi-configuration device which may be configured in one of a plurality of physical configurations for use. Accordingly, the mobile communication device further comprises a configuration detector 122 for determining in which of the plurality of physical configurations the mobile communication device is presently configured. For example, it is common in clamshell or folding mobile communication devices to use a hall effect device disposed in one portion of the mobile communication device and a magnet in a corresponding location in another portion of the mobile communication device. When the device is closed, the hall effect device detects the proximity of the magnet, indicating to the controller that the device is closed. Numerous other means have been developed for use in determining the present physical configuration of multi-configuration mobile communication devices.

According to the invention, the mobile communication device further comprises a non-resonant load which may be switchable coupled to the main antenna 108. The non-resonant load may comprise a non-resonant antenna element 126, which is disposed in proximity to the main antenna, and an impedance 124, which may have a selectable value, in accordance with an embodiment of the invention. The non-resonant antenna element is located in sufficient proximity to be, for example, capacitively coupled to the main antenna. The non-resonant antenna element differs from a parasitic element in that a parasitic element is designed to be resonant an operational frequency. Conversely, the non-resonant load may be switched in or out, changing the loading on the antenna, causing a shift in the resonant frequency of the antenna structure as well as a change in the resulting field produced by the antenna. The degree of change is determined by the value of the impedance in the non-resonant load, as well as the amount of electrical coupling between the non-resonant antenna element and the main antenna element. In an embodiment of the invention, the non-resonant load is switched on during a transmit time slot of a time division multiple access (TDMA) protocol, and switched off during a receive time slot. By switched on, it is meant that the non-resonant load is coupled to an electrical reference, such as ground. Accordingly, when the non-resonant load is switched off, it is decoupled from the electrical reference.

In addition to the transceiver 106, which may be used for higher power, longer distance communication, the mobile communication device may also comprise a local wireless network access transceiver 128, such as a personal or local area network transceiver in accordance with IEEE specifications 802.11 or 802.15.1, as is known. It is common, for example, to use an mobile communication device with an associated wireless earpiece over a personal area wireless network link, where the mobile communication device is then typically worn on the user's waist and in a closed configuration. When the mobile communication device is in a closed configuration, it exhibits different radio frequency characteristics compared to when it is used in an open configuration and held to the user's head.

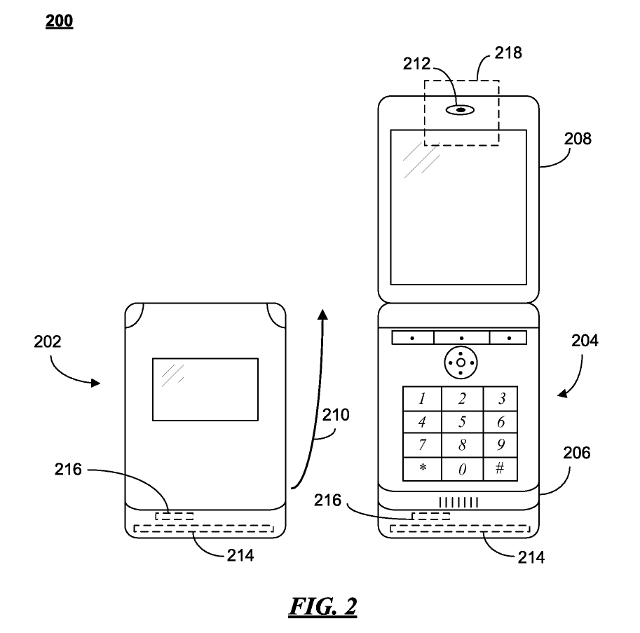

FIG. 2 shows a mobile communication device 200 in a clamshell design, in accordance with an embodiment of the invention. The mobile communication device is shown in a first configuration 202 which is a closed configuration, and a second configuration 204 which is an open configuration. The mobile communication device is generally used in the closed configuration in an idle state, or when used with an associated audio accessory, such as a wireless earpiece. The mobile communication device is generally used in the open configuration during calls to hold the mobile communication device to the user's head, or for operating the mobile communication device via keypad buttons and the graphical display. A folding or clamshell style mobile communication device is comprised of two body portions, such as main body portion 206 and a flip portion 208. The flip portion is flipped up, as indicated by arrow 210, from the closed to the open configuration. The flip portion 208 comprises an earpiece 212 on the inside of the flip portion, and is positioned at the top of the device when the flip is opened.

In one embodiment of the invention, the mobile communication device comprises an internal antenna 214, which may be disposed in the main body portion at the bottom of the device. Positioned in electrical proximity to the main antenna may be a non-resonant load or antenna element 216. The non-resonant element 216 may be coupled to an electrical reference of the mobile communication device when the mobile communication device's transceiver is transmitting, where the loading effect changes the frequency response of the main antenna such that the resonance of the main antenna changes. A thorough discussion of the operation and effect of a non-resonant element may be found in United States patent publication no. 2008/0150808 A1, titled “Switched Capacitive Patch for Radio Frequency Antennas,” and which is assigned to the assignee of the present invention. The non-resonant element, in addition to shifting the resonant frequency of the main antenna, alters the field produced by the main antenna, particularly at a location proximate to the earpiece 212. By switching in the non-resonant element during transmission, the field strength near the earpiece may be reduced, as measured, for example, in accordance with a hearing aid compatibility specification such as, for example, the prescribed by ANSI C63.19. Generally, ANSI C63.19 requires measurement be taken in a region 218 near the earpiece, in a plane that is coplanar with the surface of the mobile communication device at the earpiece but spaced 15mm away. The ANSI C63.10 standard prescribes various categories of failure of compliance, based on the field strength at locations in region 218, which is generally subdivided into a 5×5 cm area divided into a 3×3 matrix for measurement.

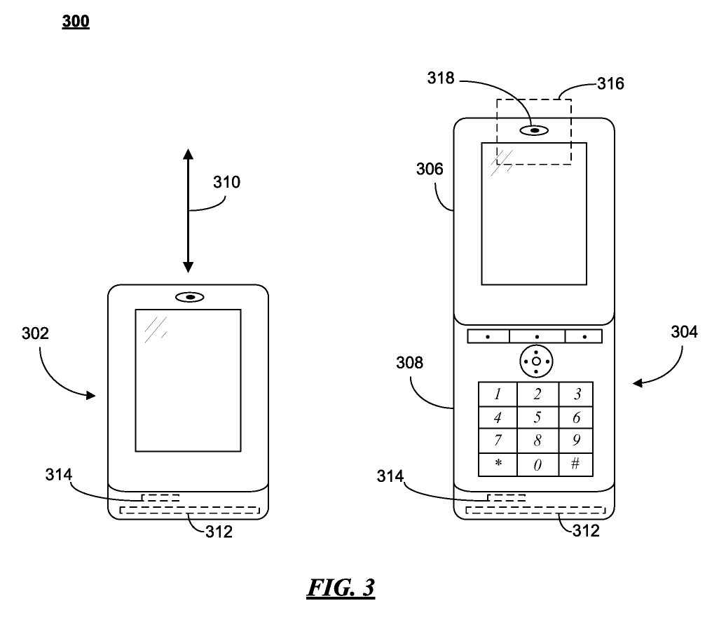

FIG. 3 shows a mobile communication device 300 in a slider design, in accordance with an embodiment of the invention. The slider style mobile communication device is shown in a closed configuration 302 and an open configuration 304. Generally, a slider style mobile communication device has a main body portion 308, and sliding portion 306, which “slides” along an axial length of the mobile communication device, as indicated by arrow 310. Sliding the slider portion up may reveal a keypad and other buttons on the main body portion. The slider mobile communication device maybe used in closed and open configurations the same as a clamshell/folding mobile communication device. When the device is in an open configuration 304, the user may access the buttons and hold the device to the user's ear during a call. When the device is closed the device may be idle or used with a wireless audio accessory. The mobile communication device 300 may also have a main internal antenna 312, and a non-resonant element 314 which may be switchably coupled to an electrical reference, and is disposed in electrical proximity to the main antenna. It will be appreciated by those skilled in the art that the precise shape and location of the main antenna element and the non-resonant element will be determined by a variety of factors in addition to the operating frequency, such as, for example, the location of the antenna within the device, the amount of space available for the two elements, and so on. It is not unusual in the design of mobile communication device to test a variety of shapes and positions to achieve the desired characteristics and performance. As with the clamshell embodiment, use of the non-resonant element 314 can reduce the field strength in a region 316 proximate to the earpiece 318 such that the field strength meets the requirements prescribed by a hearing aid compatibility specification.

Although the more common clamshell and slider configurations have been presented here, those familiar with the field will realize that mobile communication devices are manufactured in a wide variety of styles and configurations. Accordingly, the invention is not limited to a clamshell or a slider but applies to all form factors (monolith, rotators, etc.). In case of a monolith where there is only one configuration state, the controller decides to switch in the non-resonant load based on operating band and hearing aid compatibility considerations during transmission.

FIG. 4 shows an antenna structure 400 including a non-resonant load which may be switchably coupled to a main antenna, in accordance with an embodiment of the invention. A signal source 402 provides a signal into a main antenna element 404. Although shown here as a strip line, it will be appreciated that a wide variety of configurations may be used for the main antenna element, including planar antennas, patch antennas, whips, helixes, bowties, J-shaped elements, slot antennas, and other configurations. The present example is not meant to be limiting with regard to the configuration. A non-resonant element 406 is positioned in electrical proximity to the main antenna element, and may be capacitively coupled, as indicated by the phantom capacitance 408. The non-resonant element, like the main antenna element, may have a variety of configurations, with varying degrees of coupling, and is not resonant at the operating frequencies of the mobile communication device. An impedance 410 may be coupled to the non-resonant element. The value of the impedance may be selected to have the desired loading effect on the main antenna. Furthermore, it is contemplated that the value of the impedance may be selectable, such as by an input 412. The value of the impedance may be selected based on the physical configuration and the operating frequency band. The non-resonant element 406 and impedance 410 provide a non-resonant antenna element impedance configuration. To control switching of the non-resonant load, a switch 414 is provided to couple the non-resonant load to an electrical reference. The switch is controlled via a switch input 416, and switchable between an open and a closed (conductive) state. Although shown here as being capacitively coupled, it will be appreciated by those skilled in the art that the capacitance resulting from placing the non-resonant element in proximity to the main antenna element is simply one component of the impedance, which may be provided by a lump value component and using a direct, conductive connection to the main antenna element rather than an air-based capacitive coupling.

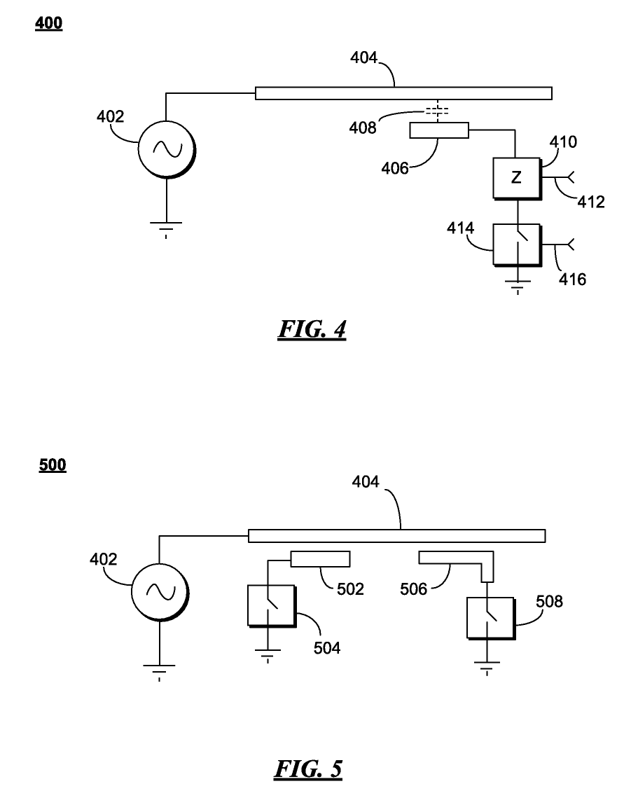

FIG. 5 shows an antenna structure 500 including a plurality of non-resonant loads which may be switchably coupled to a main antenna, in accordance with an embodiment of the invention. As an alternative to using a non-resonant element with a selectable impedance as a non-resonant antenna element impedance configuration, the present example uses multiple non-resonant elements 502 and 506, with each having different physical configurations and coupling characteristics with the main antenna element 404. It is contemplated that the inherit impedance of the non-resonant elements may be such that a lump component impedance is not needed, or, alternatively, as in FIG. 4, a lump impedance may be used with either or both non-resonant elements. Each non-resonant element 502, 506 has its own switch 504, 508, respectively. This allows four non-resonant antenna element impedance configurations, where neither may be switched on, either of the two may be switched on, or both may be switched on.

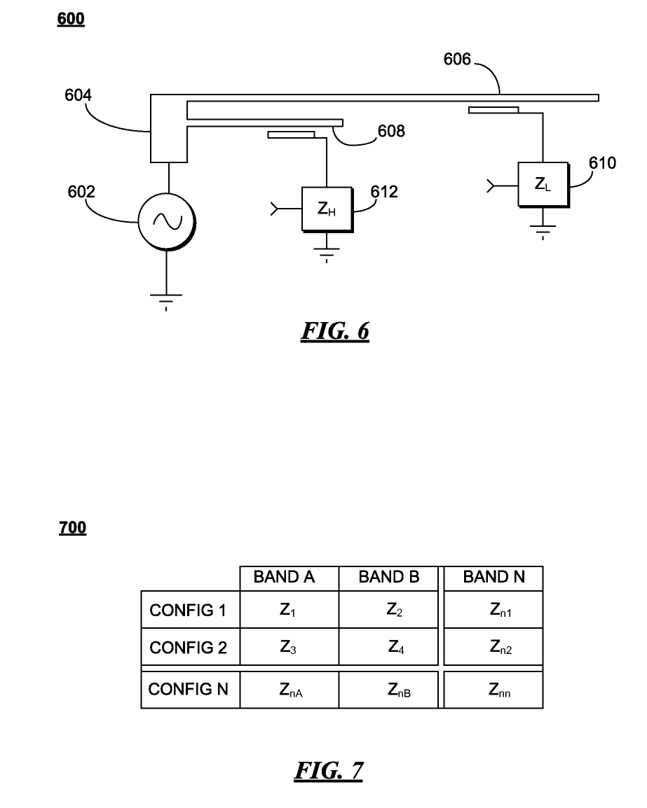

FIG. 6 shows a multi-resonant antenna structure 600 including non-resonant impedance loads, in accordance with an embodiment of the invention. A signal source 602 feeds a main antenna structure 604, which has a first resonant leg 606 and a second resonant leg 608. The first resonant leg may be resonant at a low band of operation, such as the 850 MHz band used by the GSM standard, and the second resonant leg may be resonant at a high band of operation, such as the 1.9 GHz band used by the GSM standard. The present example show the main antenna element in an “F” configuration, but it will be appreciated by those skilled in the art that there are a variety of multi-resonant configurations. Generally a multi-resonant element comprises multiple portions, each having its own resonant band. In accordance with the invention, each resonant portion 606, 608 has an associated non-resonant load 610 and 612, respectively. Each of these non-resonant loads may comprise non-resonant antenna elements which are capacitively coupled to their respective resonant elements, and which may be switchably coupled to an electrical reference. Any of the non-resonant structures discussed in regard to FIGS. 4 and 5 may be used here, as well as other non-resonant loading structures.

FIG. 7 shows a lookup table 700 for use in selecting an impedance configuration, in accordance with an embodiment of the invention. The table may be stored in a memory of the mobile communication device, and consulted upon commencing calling and other related activity where the mobile communication device will be transmitting with the transceiver, such as during calls but it may also be used during other activity such as handovers, paging responses, and so on. The table cross references physical configuration of the device (CONFIG 1, CONFIG 2) with operating frequency bands (BAND A, BAND B). The table may be scaled as necessary. For each configuration/band intersection an impedance is specified in the table. Alternatively, a digital value may be stored in the table entries which, when written to a selectable impedance configures the selectable impedance to the desired value.

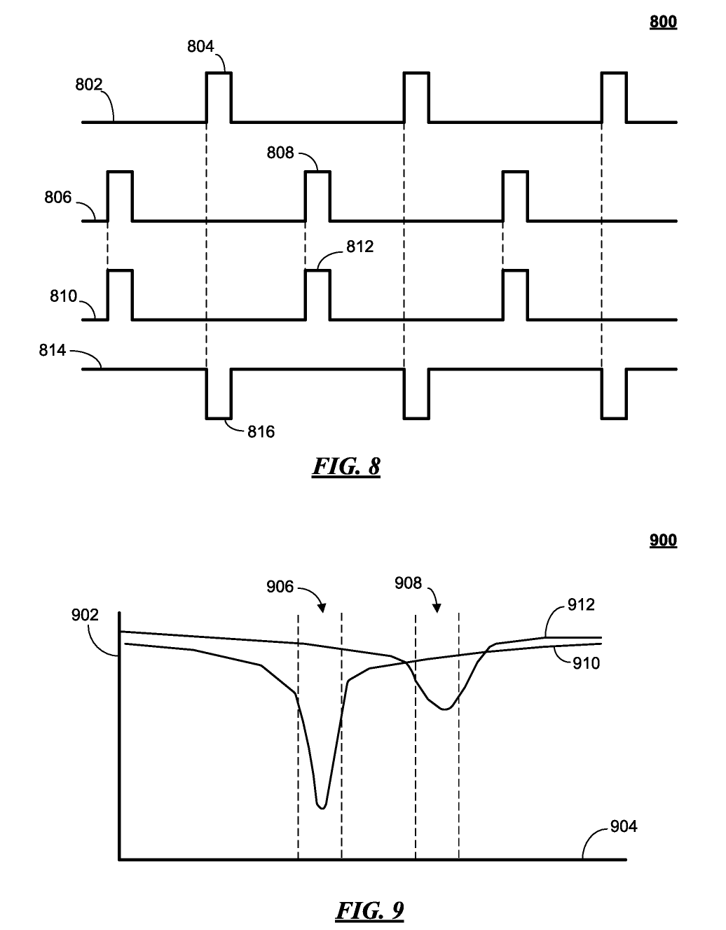

FIG. 8 shows a switch timing diagram 800 for operating switched non-resonant impedance loads, in accordance with an embodiment of the invention. A receive line 802 represents the occurrence of receive time slots 804 when the mobile communication device is receiving information on a downlink channel from, for example, a cellular base station, or other transmitting node. A transmit line 806 represents the occurrence of transmit time slots 808 when the mobile communication device may transmit on an uplink channel. Downlink and uplink channels are typically separated in frequency by some amount, such as 45 MHz in GSM systems. Accordingly, the transceiver must change frequencies between transmit and receive slots. A first switch line 810 represents switching the non-resonant load on 812 in correspondence with transmit time slots 808. When the transceiver is transmitting, the non-resonant load is coupled to the electrical reference. Alternatively, a second switch line 814 shows that the non-resonant load is switched off 816 in correspondence with receiver time slots, leaving it on otherwise. It is left as an engineering decision exactly how to control the switching of the non-resonant load, as long as it is on so that it is coupled to the electrical reference during transmit times, and off so that it is decoupled from the electrical reference during receive times.

FIG. 9 shows a graph 900 of return loss 902 verses frequency 904 for a switched and un-switched state of an impedance load, in accordance with an embodiment of the invention. The graph is generalized, and no significance should be attributed to the scale or relative values of the curves. The graph covers a frequency range of a band of operation which may be one of several bands used by the mobile communication device. For example, in GSM systems the graph may represent the 850 MHz band, with an uplink band 906 at 824 MHz to 849 MHz, and a downlink band 908 at 869 MHz to 894 MHz. A first curve 910 shows the return loss of the main antenna of the mobile communication device with the non-resonant load switched on, and a second curve 912 shows the return loss with the non-resonant load switched off. By switching the non-resonant load on, the resonant frequency of the main antenna drops into the uplink band 906, while switching the non-resonant load off moves the resonance into the downlink band 908.

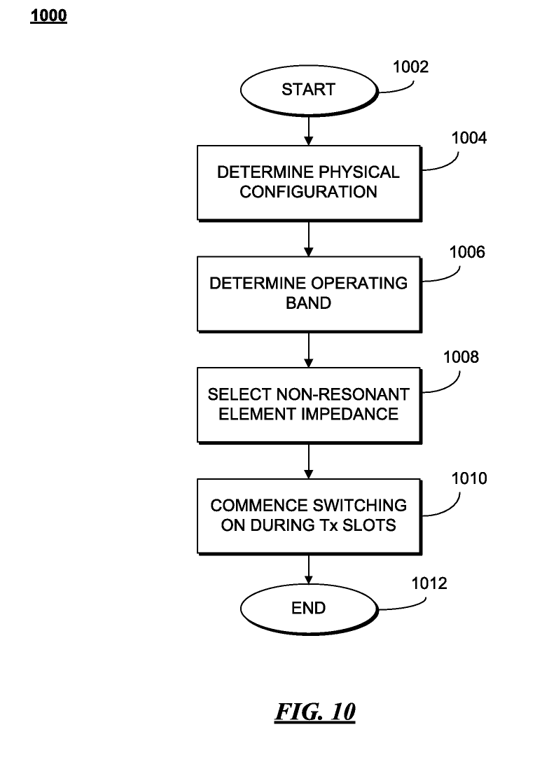

FIG. 10 shows a flow chart diagram 1000 of a method of controlling operation of a switched non-resonant impedance load, in accordance with an embodiment of the invention. At the start 1002, the mobile communication device is ready to commence communication activity. Before doing so, however, the mobile communication device must determine its present physical configuration 1004. This may be done at the time of commencing communication activity, or it may be done automatically as configuration changes, where, for example, a flag is set in a memory location indicating where the device is open or closed (or in some other configuration), and the flag simply be read upon commencing communication activity. The mobile communication device must also determine its present operating band 1006. Based on the present configuration and operating band, the mobile communication device selects the appropriate non-resonant impedance configuration for use during transmit time slots (1008), whereupon the mobile communication device commences the communication activity 1010, switching the non-resonant load on during transmit time slots. the method may end 1012 when the mobile communication device ceases communication activity.

It is contemplated that the non-resonant load may be used with only one physical configuration, such as an open configuration, to meet hearing aid compatibility specifications, for example. Alternatively, the non-resonant load may be used in any or all other configuration and operating band combinations. When multiple bands are present, and the main antenna is a multi-resonant antenna, different non-resonant elements coupled to different resonant portions of the main antenna may be activated in correspondence with the operating band. Furthermore, the method may be employed in only one or less than all of the operating bands if hearing aid compatibility is only an issue on one band, or in less than all operating bands. Selecting the non-resonant load may comprise adjusting a lumped component impedance coupled to a non-resonant antenna element which may be capacitively coupled to the main antenna. Alternatively, selecting the impedance may comprise selecting one of a plurality of non-resonant antenna elements.

It will be further appreciated by those skilled in the art that, while the invention has been exemplified here for reducing field strength near the earpiece of the mobile communication device, the inventive techniques and teaching may be applied generally to reduce field strength at one or more select locations of the mobile communication device for other purposes, or in addition to hearing aid compatibility. For example, some circuitry in a particular location of a mobile communication device may be sensitive to RF coupling with the antenna, resulting in compromised performance. Given a particular form factor of the mobile communication device, it may not be possible to move the circuitry, or provide shielding. The invention may be used to alleviate interference in such a case by reducing the field strength at the location of the circuitry. Placement of the non-resonant load and appropriate impedance are then a matter of engineering choice. Similarly, specific absorption rate (SAR) may be a concern for a particular mobile communication device design. SAR compliance is another example of a situation where it is desirable to reduce the field strength near the mobile communication device, as with HAC.

This invention can be embodied in other forms without departing from the spirit or essential attributes thereof. Accordingly, reference should be made to the following claims, rather than to the foregoing specification, as indicating the scope of the invention.

What is claimed is:

1. A method of controlling operation of a switched non-resonant antenna element in a mobile communication device, the switched non-resonant antenna element disposed in proximity to a main antenna and being switchably coupled to an electrical reference, the method comprising:
determining a configuration of the mobile communication device, wherein the mobile communication device is configurable in at least a first and a second physical configuration;
when the mobile communication device is configured in the first physical configuration, leaving the non-resonant antenna element in a decoupled state from the electrical reference; and
when the mobile communication device is configured in the second physical configuration, selectively coupling the non-resonant antenna element to the electrical reference through an impedance during a transmit slot time, and decoupling the non-resonant antenna element from the electrical reference during a receive time slot.

2. The method of claim 1, wherein the main antenna is a multi-resonant antenna for use in a plurality of frequency bands, wherein the method of claim 1 is performed when the mobile communication device is operated in a first frequency band and not performed when the mobile communication device is operated in a second frequency band.

3. The method of claim 1, wherein the main antenna is a multi-resonant antenna for use in a plurality of frequency bands, wherein the method of claim 1 is performed when the mobile communication device is operated in a first frequency band and when the mobile communication device is operated in a second frequency band.

4. The method of claim 1, wherein the main antenna is a multi-resonant antenna for use in a plurality of frequency bands, selectively coupling the non-resonant antenna element to the electrical reference comprises selectively coupling the non-resonant antenna element to the electrical reference through one of a plurality of impedances, wherein selection of the one of the plurality of impedances is selected based upon at least one of a present operating frequency of the mobile communication device or a present physical configuration of the mobile communication device.

5. The method of claim 4, wherein the selection of impedance is performed by use of a lookup table stored in a memory of the mobile communication device, wherein the lookup table cross references physical configuration of the mobile communication device with operating band of the mobile communication device.

6. The method of claim 1, wherein the main antenna produces a field having a field strength, the mobile communication device has an earpiece, coupling the non-resonant antenna element to the electrical reference reduces the field strength at a point proximate to the earpiece prescribed by a hearing aid compatibility test specification such that the field strength complies with the hearing aid compatibility test specification.

7. A method of configuring an antenna structure of a mobile communication device, comprising:
determining a configuration of the mobile communication device, wherein the mobile communication device is configurable in at least a first and a second physical configuration;
when the mobile communication device is configured in the first physical configuration, selecting a first non-resonant antenna element impedance configuration wherein a first non resonant load is coupled between an electrical reference and a main antenna during a transmit slot time, and decoupled from the electrical reference during a receive time slot; and
when the mobile communication device is configured in the second physical configuration, selecting a second non-resonant antenna element impedance configuration wherein a second non resonant load is coupled between an electrical reference and the main antenna during a transmit slot time, and decoupled from the electrical reference during a receive time slot.

8. The method of claim 7, wherein selecting the first and second non-resonant antenna element impedance configurations comprises selecting a first non-resonant antenna element and a second non-resonant antenna element, respectively, wherein the first and second non-resonant antenna elements have different loading effects on a main antenna of the mobile communication device.

9. The method of claim 7, wherein selecting the first and second non-resonant antenna element impedance configurations comprises selecting a first and second impedance through which to couple a non-resonant antenna element, wherein both the first and second non-resonant antenna element impedance configurations use the same non-resonant antenna element.

10. The method of claim 9, wherein selecting the first and second impedances is performed by use of a lookup table stored in a memory of the mobile communication device, wherein the lookup table cross references physical configuration of the mobile communication device with operating band of the mobile communication device.

11. The method of claim 7, wherein the main antenna is a multi-resonant antenna, selecting the first non-resonant antenna element impedance configuration comprises coupling the first non-resonant load between the electrical reference and a first resonant portion of the main antenna, and selecting the second non-resonant antenna element impedance configuration comprises coupling the second non-resonant load between the electrical reference and a second resonant portion of the main antenna.

12. The method of claim 7, wherein the main antenna produces a field having a field strength, the mobile communication device has an earpiece, coupling the non-resonant loads to the electrical reference reduces the field strength at a point proximate to the earpiece prescribed by a hearing aid compatibility test specification such that the field strength complies with the hearing aid compatibility test specification.

13. The method of claim 7 wherein the mobile communication device comprises two major portions moveable with respect to each other, determining the configuration of the mobile communication device comprises determining whether the mobile communication device is in an open or a closed configuration.

14. The method of claim 13, wherein when the mobile communication device is in the closed configuration, further comprises connecting to a local device using a personal area network.

15. A mobile communication device, comprising:
a first body portion and a second body portion, wherein the first and second body portions are moveable with respect to each such that the mobile communication device is operable in at least a first physical configuration and a second physical configuration;
a main antenna; and
at least one non-resonant impedance load which is switchably coupled between the main antenna and an electrical reference during a transmit slot time, and decoupled from the electrical reference during a receive time slot when the mobile communication device is configured in the first physical configuration.

16. A mobile communication device as defined in claim 15, wherein the at least one non-resonant load comprises a non-resonant antenna element which is capacitively coupled to the main antenna during the transmit time slot and decoupled from the main antenna during the receive time slot.

17. A mobile communication device as defined in claim 16, wherein the non-resonant load further comprises a selectable impedance in series with the non-resonant antenna element, wherein the selectable impedance is selectable to one of a plurality of impedance values based on the configuration of the mobile communication device.

18. A mobile communication device as defined in claim 15, wherein the main antenna is a multi-resonant antenna, the mobile communication device operates on one of a plurality of frequency bands, the non-resonant impedance is selectable based on a present frequency band of operation as well as a configuration of the mobile communication device.

19. A mobile communication device as defined in claim 18, wherein the mobile communication device selects a value of the non-resonant impedance by use of a lookup table stored in a memory of the mobile communication device, wherein the lookup table cross references physical configuration of the mobile communication device with operating band of the mobile communication device.

20. A mobile communication device as defined in claim 15, wherein the main antenna is disposed in the first body portion, the mobile communication device further comprises an earpiece disposed in the second body portion, and wherein the main antenna produces a field having a field strength, coupling the non-resonant load to the electrical reference reduces the field strength at a point proximate to the earpiece prescribed by a hearing aid compatibility test specification such that the field strength complies with the hearing aid compatibility test specification.
